(19) United States
(12) Patent Application Publication
(10) Pub. No.: US 2007/0182536 A1
(43) Pub. Date: Aug. 9, 2007

(54) Apparatus for producing heads-up display in a vehicle and associated methods

(76) Inventor: Arnold S. Prywes, Dix Hills, NY (US)

Correspondence Address: LADAS & PARRY, 26 WEST 61ST STREET, NEW YORK, NY, 10023, US

(21) Appl. No.: 11/582,856

(22) Filed: Oct. 18, 2006

Related U.S. Application Data
(60) Provisional application No. 60/728,219, filed on Oct. 19, 2005.

(51) Int. Cl. B60Q 1/00; G09F 9/00; G08G 1/123

(52) U.S. Cl. 340/461; 340/995.1

(57) ABSTRACT

A portable device is provided for heads-up display in a motor vehicle without requiring permanent physical attachment to the vehicle. The heads-up device has a portable housing with inputs for wirelessly obtaining a multitude of parameters related to vehicle operation. The input signals are transformed into visual signals and a projector in the housing projects the visual signals as a heads-up display image on the windshield of the vehicle.

### CROSS-REFERENCE TO RELATED APPLICATIONS

The present invention claims the benefit of U.S. Provisional Patent Application No.: 60/728,219 filed Oct. 19, 2005, which is hereby incorporated by reference in its entirety.

### FIELD OF THE INVENTION

The present invention relates to a small, portable self-contained or modular device for producing a heads up display (HUD) on the windshield of a vehicle. Although the invention will be described with reference to a motor vehicle it is also applicable to motorcycles, airplanes, boats, motorized wheelchairs or other transportation devices, or to non- moving devices, such as a computer control terminal or work station.

The invention also relates to methods of producing the heads-up display.

### DESCRIPTION OF PRIOR ART

In transportation, it is desirable to have information instantaneously available to monitor the functions of the moving vehicle. Present means include dashboard display units such as speedometers, odometers, fuel gauges, engine temperature gauges, transmission function and the like, often with illuminated dials. Display units with these functions displayed on a windshield or a similar transparent screen are used in commercial and other vehicles. Vehicles that provide this type of heads up display are frequently expensive, large and stationary, thereby rendering them unavailable to most consumers.

The built-in nature of these devices and the limitation of the features that these units contain make them available for only a single purpose or vehicle. For example, an automobile having a heads up display showing only a speedometer might not make available an interactive map and Global Positioning System (GPS ) program as a part of the heads up display. A separate stationary or a separate portable display device could be used, hence requiring more viewing away from the windshield. Viewing all of these functions below the line of sight on the dashboard distracts the motor vehicle operator and having a multiplicity of dials and controls requiring adjustments increases the likelihood of accidents.

A significant number of households will sell or lease motor vehicles during the course of their lives. Purchasing specialized features such as a GPS system is expensive. The general lack of portability when purchasing this option in a new vehicle, and the lack of heads up display make it less useful.

A voice-activated telephone with use of an automobile audio system exists and special inputs and adaptors can be used to make them hands-free. The rapid changes in technology and multiple vendors make these phones and their adaptors costly when new phones with different features become available.

Also known is an after market installation in which a device is connected to the cables supplying the speed signals to the speedometer to convert these speed signals to a projector to display a visual image of the vehicle speed on the vehicle windshield. This system is complex and requires hard wiring to the vehicle by knowledgeable and competent personnel.

### SUMMARY OF THE INVENTION

It is therefore an object of the present invention to provide an apparatus which will allow GPS, mobile phones, video and entertainment means and other inputs to integrate into a central portable means allowing the functions to be provided to the operator in real time on a heads up display and wherein the apparatus can be used in other vehicles and locations without the need for replacing the apparatus when the automobile or other vehicle is sold.

In order to achieve the above and other objects of the invention, the portable heads up display unit according to the present invention includes the following elements:
a portable housing containing:
   means for controlling size, contrast, color and sharpness of the displayed image;
   means for powering the unit by a battery or external supply of direct or alternating current;
   a computing means for controlling and integrating data from the motor vehicle or an outside source;
   a multiplicity of inputs for receiving data from other devices within and outside of the vehicle or location for supply to the computer; and
   a projector for producing a heads-up display of the data.

The portability of the unit allows the unit to be used in a multiplicity of vehicles or locations such that the owner is able to transport and connect it simply, thereby allowing the owner to use it in a rental car, a second car, motor scooter, airplane, truck, boat or train, etc. as well as in the home or workplace.

Other features include a power supply from a battery, an alternating current source, or a direct current supply from a cigarette lighter.

An additional feature is the use of a small yet powerful CPU which could have multiple application programs which could be customized for the individual user with some or all of the programs being visualized simultaneously or individually.

Applications included for an automobile include speedometer, fuel gauge, odometer, trip odometer, compass, global positioning system with maps, engine condition, seatbelt use, and electrical and light status. In addition the device could provide information or entertainment with display and audio also available through the vehicle's audio system through wires or transmitted wirelessly by radio or other frequency connection, with additional display features available to rear seats or in several locations with one computer but a multiplicity of display modules. The ability to simultaneously display different information to the front passengers and rear passengers using two separate display modules but one computer box would be a variation of the device.

A further feature of the invention is to provide integrated or receptacle input(s) from other devices for the use of voice control. This feature enables the driver to operate the unit without the use of his or her hands. The displayed features could be controlled by use of voice. For example: the driver would say “speed” into a microphone which could be worn or integrated into the device thereby making the speedometer visible on the display. “Speed-off” would make the display disappear.

An additional utility of the voice feature would allow physically disabled individuals operating motorized vehicles (i.e. battery operated wheelchairs, etc) to view information from the device or their bed.

An additional utility of the voice feature allows the size, contrast and color of the display to be modulated for individuals with visual disabilities

The use of a suction cup or other detachable connection, such as Velcro™, clamps or the like can be used to fix the position of the device

An adjustment means such as a button, knob, dial or toggle can be used to adjust the focus, light intensity, size, color, power, or volume of the display device. Alternatively voice activation can be employed.

A further feature is to provide a means to set various default settings for different users, thereby making the device available to a multiplicity of users in a family, or company car. One such rapid method for determining a user could be to display an initial screen of user names or other identifiers such as code names or numbers. Manual means to activate this feature or voice activation-recognition would allow “voice print” security for each set of default displays and settings which could be changed easily and quickly by using commands such as “Display John” or “Display John off” to display and turn off the default settings for a driver or passenger whose name is John.

Further features include integrated or receptacle input(s) from other devices including but not limited to audio-visual devices containing music, video, video games (ie PlayStation™, Gameboy™, Ipod™, etc.) in various formats.

Further features include integrated or receptacle input(s) from telecommunication devices such as mobile telephones, combinations of mobile telephones and personal digital assistants (i.e. Blackberry™, Treo™ or other) or video display telecommunications devices.

Further features include integrated or receptacle input(s) from connectivity communication/device software/hardware employing WiFi, Bluetooth™, USB 1, 2 and future versions, LAN, VPN, WAN and other computer software/hardware communications.

Further features include integrated or receptacle input(s) from radio frequency, cable, optical fiber, satellite communications or other methodology for telecommunications.

Further features include integrated or receptacle input(s) for docking ports and stations allowing the unit to be easily placed in a multiplicity of sites with rapid connections of all inputs without requiring individual connections to be used. Standard available ports or stations could be used made by others, or a customizable station for the designated unit and design features could be manufactured.

### BRIEF DESCRIPTION OF THE DRAWINGS

FIG. 1 is a front view of a portable heads-up device according to the invention.

FIG. 2 is a rear view of the device in FIG. 1.

FIG. 3 shows the device of FIG. 1 mounted on a vehicle dashboard.

FIG. 4 is a schematic circuit diagram of the heads-up device.

### DETAILED DESCRIPTION OF THE INVENTION

FIG. 3 shows the heads-up display device 10 according to the invention mounted on the dashboard 11 of a vehicle. The heads-up display device 10 is constituted in a manner to be described more fully later to project a light beam onto the windshield 13 of the vehicle to produce a heads-up display image on the windshield 13. The heads up display image contains information relating to parameters of vehicle operation, such as vehicle speed, total vehicle mileage, fuel economy, fuel quantity, engine rpm, coolant temperature, oil pressure, battery state and the like. The information displayed is equivalent to that normally displayed on the dashboard 11.

The display device 10 comprises a housing 14 containing electrical circuitry for producing light image signals fed to a projector 15 which projects a light beam, based on said signals, onto the vehicle windshield 13 as a heads-up display. The heads-up display image is transparent and allows the driver to view the conditions in front of the vehicle in normal fashion through the heads-up display. Such heads-up displays are well known and are presently available as systems built into vehicles. The display device of the invention is an after-market system which is portable and capable of being used to produce the same heads-up display as those which are built into the vehicle.

Referring to FIG. 1 therein is shown the heads-up display device 10 which comprises housing 14 which incorporates various systems and controls. The housing 14 has feet 2, 2a at the bottom thereof for attachment to the top surface of the dashboard 11. Preferably, the feet 2, 2a provide detachable attachment to the dashboard, for example, by suction cups, magnetic means or Velcro™. The feet 2, 2a are adjustably secured at the bottom of the housing 14 so that they can be extended or retracted in order to be adapted to the contour of the surface of the dashboard.

At the front of the housing 14 are a number of input receptacles 1a-1e for input of data from peripheral devices such as map inputs, music inputs, video inputs or the like.

The heads-up display device 10 can be self-powered by replaceable or rechargeable internal batteries or it can be connected by a cable 3 having a power plug 4 for insertion into a power supply on the vehicle. An on-off button 5 is disposed at the front of the housing to control power supply to the display device 10.

A microphone 6 is built into the housing 14 to receive voice input commands from the driver. Also, disposed at the front of the housing is an ambient light sensor for control of the light intensity of the image projected onto the windshield. A display screen 8 is provided at the front of the housing 14 to indicate program selection and other information such as on-off status of the power supply.

Mounted at the front of the housing is a miniature video camera 16 which is connected to the housing by a flexible self sustaining cable 17. The camera 16 is adjustable to view the dashboard instruments and provide a continuous video signal of an image thereof In this way all the information provided on the dashboard display is transmitted as an input into the housing. Although the camera has been shown as attached to the display device 10, it could also be separate from the display device and transmit its video signals thereto wirelessly.

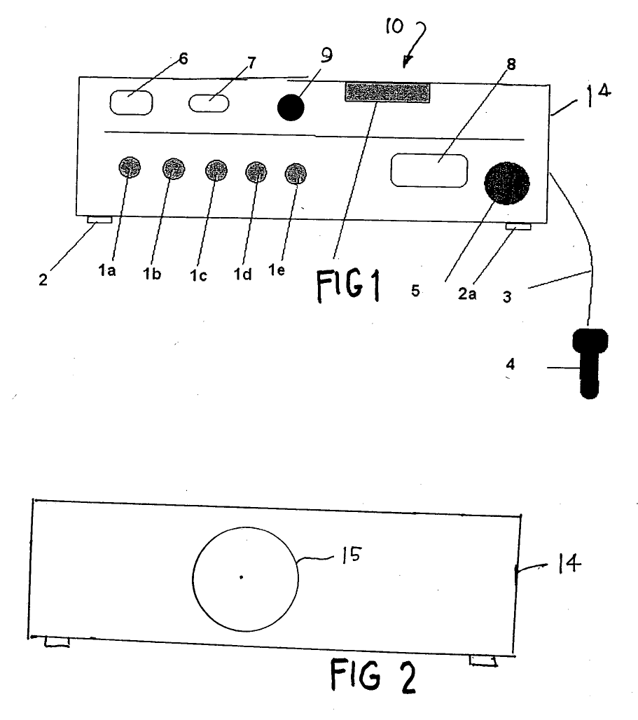

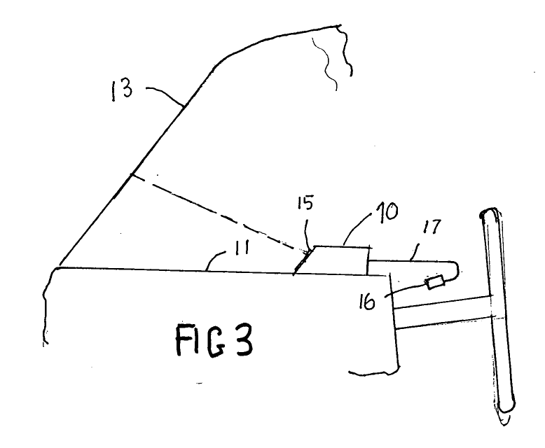

FIG. 2 shows the projector 15 centered at the back of the housing 14 to project the heads-up display image onto the windshield. The projector 15 can be mounted for angular adjustment in all directions to center the heads-up display image on the windshield in front of the driver.

The projector 15 can be miniaturized by recent technological developments, such as DLP technology which not only makes the projector smaller but also miniaturizes the size of the housing 14 and the overall display device 10.

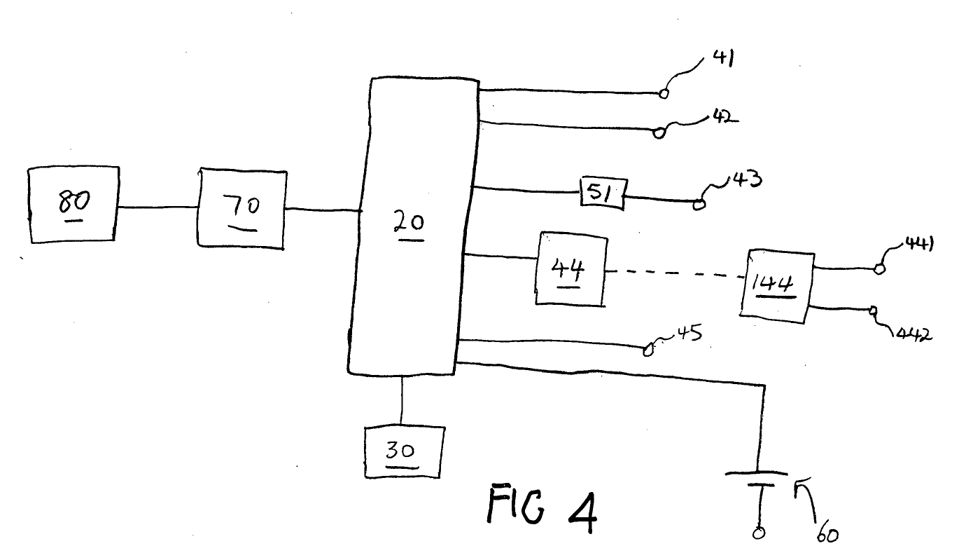

FIG. 4 is a schematic diagram of the construction of the heads-up device and the elements shown in FIG. 4 are incorporated into the housing 14.

The main control unit of the heads-up device is a CPU 20 which is connected to a storage unit 30, for example, a hard drive for storing programmed information. An input 41 is connected to the microphone for receiving voice instructions therefrom. An input 42 is connected to the ambient light sensor 7 to receive signals therefrom. An input 43 is connected to the video camera 16. The input 43 is connected to the CPU 20 through an A/D converter 51. Numeral 60 designates the power supply which can be either external or an internal battery as previously described. Numeral 44 designates a wireless transmitter/receiver for receiving signals from a wireless transmitter 144. The wireless transmitter 144 has inputs 441 and 442 respectively connected to a GPS system and an automobile on-board computer (not shown). More specifically, input 441 receives satellites signals from the GPS system. The CPU is programmed to produce output signals for display in the heads-up display of images normally presented in conventional navigator systems, notably vehicle speed and direction of travel. The program can produce further information such as map information and the like. The software program for the GPS system can also include various features, such as menu selection enabling the selection of the information to be displayed in the heads-up image.

The input 442 receives signals from a conventional on-board computer (not shown) which supplies information regarding engine operation for diagnostic purposes. The on-board computer conventionally has an interface for external connection to evaluate engine condition. A transmitter (not shown) is connected to the interface to send signals from the on-board computer to the input 442. These signals can be sent to obtain engine rpm temperature etc.

Input 45 is connected to the power on-off button 8 and selector 9.

The CPU 20 is connected to a graphic processor 70 which converts digital output signals from the CPU into visual signals which can be supplied to processor 80 of the projector 15 for projecting the light beam containing the heads-up display information onto the windshield.

It is thus seen that the invention provides a small compact portable device 10 capable of being detactably connected on the dashboard of a vehicle and adapted for wirelessly receiving external signals via satellite of a GPS system, an on-board computer of the vehicle and the camera 16 integral with device 10 to provide the heads-up display on the windshield. Accordingly, the device can be moved from vehicle to vehicle without requiring any physical connection to the vehicle.

Although the invention has been described in relation to a particular embodiment thereof it will be apparent to those skilled in the art that numerous modifications and variations can be made within the scope of the invention as defined in the attached claims.

What is claimed is:

1. A portable device for heads up display in a motor vehicle comprising:
a portable housing;
means associated with the housing for wirelessly receiving at least one signal indicative of a parameter associated with vehicle operation;
means for forming said at least one signal into a visual signal; and
a projector for receiving said visual signal and projecting a visual image in a heads up display onto a windshield of the vehicle.

2. The portable device as claimed in claim 1, wherein said means for obtaining said at least one signal is portable with said housing.

3. The portable device as claimed in claim 1, wherein said means for receiving said at least one signal is included in said housing.

4. The portable device as claimed in claim 1, wherein said means for receiving said at least one signal comprises an input for receiving signals from a camera.

5. The portable device as claimed in claim 4, wherein said camera is aimed at a display on a dashboard of the vehicle to produce visual images of said display.

6. The portable device as claimed in claim 5, comprising means for transforming said visual images from said camera into a signal supplied to said projector for projecting an image on the windshield representing said at least one parameter.

7. The portable device as claimed in claim 6, wherein the transforming means comprises a CPU.

8. The portable device as claimed in claim 4, wherein the camera is connected to the housing.

9. The portable device as claimed in claim 1, wherein said means for receiving said at least one signal comprises an input for a GPS satellite signal.

10. The portable device as claimed in claim 9, comprising a GPS receiver including a program to provide a signal representing vehicle speed and direction.

11. The portable device as claimed in claim 1, wherein said means for receiving said at least one signal includes an input for receiving signals from an on-board computer installed on the vehicle.

12. The portable device as claimed in claim 11, wherein said on-board computer provides a signal representing engine speed.

13. The portable device as claimed in claim 1, wherein said housing includes attachment means for detachable connection to the vehicle at a position at which the projector can project said visual image on the vehicle windshield.

14. A method of producing a heads-up display on a windshield of a vehicle, comprising the steps of.
wirelessly receiving a signal of at least one parameter representing vehicle operations,
producing an output signal of said at least one parameter,
feeding said output signal to a projector,
projecting an image of said at least one parameter from said projector onto the windshield of the vehicle as a heads up display of said at least one parameter;
mounting said projector in a housing and supporting the housing on the vehicle in a position in which said image can be projected onto the windshield.

15. The method as claimed in claim 14, wherein said housing is detachably mounted on the vehicle.

16. The method as claimed in claim 14, wherein said signal of said at least one parameter comprises a GPS signal from a satellite.

17. The method as claimed in claim 14, wherein said signal of said at least one parameter comprises an output signal from an on-board computer of the vehicles.

18. The method as claimed in claim 14, comprising positioning a camera to view gauges on the vehicle displaying parameters related to vehicle operation and supplying image signals produced by the camera as signals of the displayed parameters.
